(19) United States
(12) Patent Application Publication
(10) Pub. No.: US 2005/0264971 A1
(43) Pub. Date: Dec. 1, 2005

(54) Semiconductor integrated circuit apparatus having overheat protection circuit and overheat protection method

(76) Inventor: Koichi Morino, Kanagawa-ken (JP)

Correspondence Address: COOPER & DUNHAM, LLP, 1185 AVENUE OF THE AMERICAS, NEW YORK, NY, 10036, US

(21) Appl. No.: 11/140,436

(22) Filed: May 27, 2005

(30) Foreign Application Priority Data
Jun. 1, 2004 (JP) 2004-162941

(51) Int. Cl. H02H 5/04

(52) U.S. Cl. 361/103

(57) ABSTRACT

A semiconductor integrated circuit apparatus includes an overheat protection circuit including a voltage generating circuit, a voltage comparing circuit, and a voltage outputting circuit. The voltage generating circuit generates two reference voltages having substantially equivalent responsiveness to an input voltage and different variation gradients with respect to a temperature change such that the different variation gradients intersect with each other at a predetermined temperature. The voltage comparing circuit compares the two reference voltages generated by the voltage generating circuit. The voltage outputting circuit outputs an output voltage when the different variation gradients do not intersect and changes the output voltage to an inverse output voltage upon intersection of the different variation gradients to stop an operation of circuits included in the semiconductor integrated circuit apparatus. An overheat protection method is also described.

### BACKGROUND

1. Field

This patent specification relates to a semiconductor integrated circuit apparatus having an overheat protection circuit and an overheat protection method. More particularly, this patent specification relates to a semiconductor integrated circuit apparatus having an overheat protection circuit and an overheat protection method capable of desirably setting a detection temperature, with two input terminals of a comparator being connected to elements of similar characteristics to keep a constant relationship between two voltages input in the two input terminals despite a change in an input voltage input in the semiconductor integrated circuit.

2. Discussion of the Background

FIG. 1 illustrates an example of a background semiconductor circuit. A voltage regulator circuit 1 shown in FIG. 1 includes a background overheat protection circuit 2. The voltage regulator circuit 1 includes a reference voltage circuit (RV) 31, a differential amplifier circuit (DA) 41, an output driver M20, resistors Ra and Rb, and an output terminal OUT. The overheat protection circuit 2 includes a temperature monitoring circuit 30 and a cut-off circuit 20. The temperature monitoring circuit 30 includes a reference voltage circuit (RV) 11, a comparator circuit (CMP) 21, a constant current circuit 51, and a diode D1, while the cut-off circuit 20 includes a p-channel transistor M10. The overheat protection circuit 2 and the voltage regulator circuit 1 receive an input voltage Vin input in an input terminal IN, and the voltage regulator circuit 1 outputs an output voltage Vout from the output terminal OUT.

In the voltage regulator circuit 1 of FIG. 1, an output terminal of the overheat protection circuit 2 is connected to a gate of the output driver M20 which is a p-channel transistor. An output voltage output from the reference voltage circuit 31 is input in an inverting input terminal of the differential amplifier circuit 41, and an output voltage output from the differential amplifier circuit 41 is input in the gate of the output driver M20. A drain of the output driver M20 is connected to the output terminal OUT of the voltage regulator circuit 1. The output terminal OUT of the voltage regulator circuit 1 is also connected to the resistors Ra and Rb. The resistors Ra and Rb form a voltage divider circuit which divides the output voltage Vout to generate and input a feedback voltage in a non-inverting input terminal of the differential amplifier circuit 41.

In the overheat protection circuit 2, a reference voltage Vref1 output from the reference voltage circuit 11 is input in an non-inverting input terminal of the comparator circuit 21. Meanwhile, an inverting input terminal of the comparator circuit 21 is connected to a connection point A1 between the constant current circuit 51 and the diode D1 which are connected in series. An output terminal of the comparator circuit 21 is connected to a gate of the p-channel transistor M10, and a drain of the p-channel transistor M10 is connected to the gate of the output driver M20 in the voltage regulator circuit 1. Since a relatively low power consuming CMOS (Complementary Metal Oxide Semiconductor) circuit is included in the reference voltage circuit 11 and the constant current circuit 51, the reference voltage circuit 11 and the constant current circuit 51 may have a problem which does not occur in a relatively high power consuming bipolar transistor circuit.

In the overheat protection circuit 2, the reference voltage Vref1 is kept at a constant value irrespective of a temperature of a semiconductor integrated circuit including the overheat protection circuit 2. Since a constant current flows through the diode D1, a voltage at the connection point A1 increases at a rate of two millivolts per degree Celsius as the temperature of the semiconductor integrated circuit increases.

FIG. 2 illustrates temperature characteristics of the reference voltage Vref1 and the voltage of the connection point A1 in the overheat protection circuit 2 shown in FIG. 1. As observed in FIG. 2, when the temperature of the semiconductor integrated circuit increases and the voltage of the connection point A1 exceeds the reference voltage Vref1, the output voltage output from the comparator circuit 21 shifts from a high level (HIGH) to a low level (LOW). As a result, the p-channel transistor M10 is turned on, and the output driver M20 of the voltage regulator circuit 1 is turned off. Accordingly, the output driver M20 stops outputting the output voltage Vout.

In this manner, the overheat protection circuit 2 detects an increase in the temperature of the semiconductor integrated circuit and turns off the output driver M20, so that overheat of the semiconductor integrated circuit can be prevented. A detection temperature detected by the overheat protection circuit 2 may be set based on a difference between the reference voltage Vref1 and the voltage of the connection point A1 which are measured at room temperature (e.g., 25 degrees Celsius).

The reference voltage Vref1 and the voltage of the connection point A1, however, are generated by substantially different circuits. Accordingly, the reference voltage Vref1 and the voltage of the connection point A1 respond to an instantaneous change of the input voltage Vin at different response speeds. Therefore, if the input voltage Vin instantaneously changes in a state in which the temperature of the semiconductor integrated circuit is below the detection temperature of the overheat protection circuit 2 (i.e., when the reference voltage Vref1 is higher than the voltage of the connection point A1), there is a moment when the reference voltage Vref1 falls below the voltage of the connection point A1. In this event, the output voltage output from the comparator circuit 21 shifts in the level, and the cut-off circuit 20 is turned on and the output driver M20 is turned off. This type of operational error frequently occurs in the CMOS circuit. Despite this disadvantage, the CMOS circuit is used as the reference voltage circuit 11 for its relatively low power consuming characteristics.

Turning on of the cut-off circuit 20 at a temperature below the detection temperature is an operational error. In light of this, there has been a demand for an overheat protection circuit unaffected by the instantaneous change of the input voltage.

Operational errors caused by noise are discussed in the Japanese Laid-Open Patent Publication No. 2000-311985, for example. A semiconductor device described in the patent publication includes a first protection circuit for detecting a first temperature T1 and a second protection circuit for detecting a second temperature T2 which is higher than the first temperature T1. In this semiconductor device, the first protection circuit forces the semiconductor device to be turned off when a temperature of the semiconductor device continues to exceed the first temperature T1 for a predetermined time period. The second protection circuit forces the semiconductor device to be turned off immediately after detecting that the temperature of the semiconductor device exceeds the second temperature T2. Accordingly, erroneous turn-off of the semiconductor device can be prevented in a normal operation state in which the temperature of the semiconductor device is lower than the first temperature T1, even when a noise occurs in the first protection circuit.

The semiconductor device, however, includes two protection circuits and an additional circuit which sets the predetermined time period. This increases a circuit size. Further, in this semiconductor device, the predetermined time period is set to be longer than a pulse width of an expected noise. In a general-purpose semiconductor integrated circuit used for a variety of purposes, however, it is difficult to determine the pulse width of the expected noise.

### SUMMARY

This patent specification describes a novel semiconductor integrated circuit apparatus. In one example, a novel semiconductor integrated circuit apparatus includes an overheat protection circuit which includes a voltage generating circuit, a voltage comparing circuit, and a voltage outputting circuit. The voltage generating circuit is configured to generate two reference voltages having substantially equivalent responsiveness to an input voltage and different variation gradients with respect to a temperature change such that the different variation gradients intersect with each other at a predetermined temperature. The voltage comparing circuit is configured to compare the two reference voltages generated by the voltage generating circuit. The voltage outputting circuit is configured to output an output voltage when the different variation gradients do not intersect and changes the output voltage to an inverse output voltage upon intersection of the different variation gradients to stop an operation of circuits included in the semiconductor integrated circuit apparatus.

This patent specification further describes another novel semiconductor integrated circuit apparatus. In one example, this novel semiconductor integrated circuit apparatus includes an input terminal and an overheat protection circuit. The overheat protection circuit includes a temperature monitoring circuit and a cut-off circuit. The temperature monitoring circuit is configured to monitor a temperature of the semiconductor integrated circuit apparatus. The cut-off circuit is configured to stop an operation of circuits included in the semiconductor integrated circuit apparatus according to an output signal output from the temperature monitoring circuit. The temperature monitoring circuit includes a first series circuit, a second series circuit, and a differential amplifier circuit. The first series circuit is configured to connect a first resistor to a first diode group including plurality of series-connected diodes and to connect the first diode group to a first constant current circuit, and the first resistor is connected to the input terminal. The second series circuit is configured to connect a second resistor to a second diode group including another plurality of series-connected diodes and to connect the second diode group to a second constant current circuit, and the second resistor is connected to the input terminal. The differential amplifier circuit includes a first input terminal to receive a first forward output voltage of the first diode group and a second input terminal to receive a second forward output voltage of the second diode group.

In the semiconductor integrated circuit apparatus, the temperature monitoring circuit may have a thermal hysteresis.

In the semiconductor integrated circuit apparatus, laser trimming may be performed in a post-process to adjust a resistance value of one of the first and second resistors or a constant current value of one of the first and second constant current circuits.

In the semiconductor integrated circuit apparatus, the first and second resistors may be replaced by a constant voltage circuit which outputs two different voltages.

In the semiconductor integrated circuit apparatus, the first input terminal of the differential amplifier circuit may be connected to a connection point between two diodes included in the first diode group, and the second input terminal of the differential amplifier circuit may be connected to a connection point between two diodes included in the second diode group.

In the semiconductor integrated circuit apparatus, the temperature monitoring circuit may include a complementary metal oxide semiconductor circuit.

This patent specification further describes another novel semiconductor integrated circuit apparatus. In one example, this novel semiconductor integrated circuit apparatus includes an input terminal and an overheat protection circuit. The overheat protection circuit includes a temperature monitoring circuit and a cut-off circuit. The temperature monitoring circuit is configured to monitor a temperature of the semiconductor integrated circuit apparatus. The cut-off circuit is configured to stop an operation of circuits included in the semiconductor integrated circuit apparatus according to an output signal output from the temperature monitoring circuit. The temperature monitoring circuit includes a first series circuit, a second series circuit, and a differential amplifier circuit. The first series circuit is configured to connect a first constant current circuit to a first diode group including a plurality of series-connected diodes and to connect the first diode group to a first resistor, and the first constant current circuit is connected to the input terminal. The second series circuit is configured to connect a second constant current circuit to a second diode group including another plurality of series-connected diodes and to connect the second diode group to a second resistor, and the second constant current circuit is connected to the input terminal. The differential amplifier circuit includes a first input terminal to receive a first forward output voltage of the first diode group and a second input terminal to receive a second forward output voltage of the second diode group.

In the semiconductor integrated circuit apparatus, the temperature monitoring circuit may have a thermal hysteresis.

In the semiconductor integrated circuit apparatus, the first and second resistors may be replaced by a constant voltage circuit which outputs two different voltages.

In the semiconductor integrated circuit apparatus, the first input terminal of the differential amplifier circuit may be connected to a connection point between two diodes included in the first diode group, and the second input terminal of the differential amplifier circuit may be connected to a connection point between two diodes included in the second diode group.

In the semiconductor integrated circuit apparatus, the temperature monitoring circuit may include a complementary metal oxide semiconductor circuit.

This patent specification further describes a novel overheat protection method for protecting a semiconductor integrated circuit apparatus from overheat. In one example, a novel overheat protection method for protecting a semiconductor integrated circuit apparatus from overheat includes: generating two reference voltages having substantially equivalent responsiveness to an input voltage and different variation gradients with respect to a temperature change such that the different variation gradients intersect with each other at a predetermined temperature; comparing the two reference voltages; outputting an output voltage when the different variation gradients do not intersect; and changing the output voltage to an inverse output voltage upon intersection of the different variation gradients to stop an operation of circuits included in the semiconductor integrated circuit apparatus.

This patent specification further describes another novel overheat protection method for protecting a semiconductor integrated circuit apparatus from overheat. In one example, this novel overheat protection method for protecting a semiconductor integrated circuit apparatus from overheat includes: providing an input terminal and an overheat protection circuit configured to include a temperature monitoring circuit and a cut-off circuit; providing the temperature monitoring circuit with a first series circuit, a second series circuit, and a differential amplifier circuit configured to have first and second input terminals; forming the first series circuit by connecting a first resistor to a first diode group including a plurality of series-connected diodes and connecting the first diode group to a first constant current circuit; connecting the first resistor to the input terminal; forming the second series circuit by connecting a second resistor to a second diode group including another plurality of series-connected diodes and connecting the second diode group to a second constant current circuit; connecting the second resistor to the input terminal; inputting a first forward output voltage of the first diode group into the first input terminal of the differential amplifier circuit; inputting a second forward output voltage of the second diode group into the second input terminal of the differential amplifier circuit; causing the temperature monitoring circuit to monitor a temperature of the semiconductor integrated circuit apparatus; and causing the cut-off circuit to stop an operation of circuits included in the semiconductor integrated circuit apparatus according to an output signal output from the temperature monitoring circuit.

The overheat protection method may further include providing the temperature monitoring circuit with a thermal hysteresis.

The overheat protection method may further include performing laser trimming in a post-process to adjust a resistance value of one of the first and second resistors or a constant current value of one of the first and second constant current circuits.

In the overheat protection method, the first and second resistors may be replaced by a constant voltage circuit which outputs two different voltages.

The overheat protection method may further include: connecting the first input terminal of the differential amplifier circuit to a connection point between two diodes included in the first diode group; and connecting the second input terminal of the differential amplifier circuit to a connection point between two diodes included in the second diode group.

The overheat protection method may further include including a complementary metal oxide semiconductor circuit in the temperature monitoring circuit.

This patent specification further describes another novel overheat protection method for protecting a semiconductor integrated circuit apparatus from overheat. In one example, this novel overheat protection method for protecting a semiconductor integrated circuit apparatus from overheat includes: providing an input terminal and an overheat protection circuit configured to include a temperature monitoring circuit and a cut-off circuit; providing the temperature monitoring circuit with a first series circuit, a second series circuit, and a differential amplifier circuit configured to have first and second input terminals; forming the first series circuit by connecting a first constant current circuit to a first diode group including a plurality of series-connected diodes and connecting the first diode group to a first resistor; connecting the first constant current circuit to the input terminal; forming the second series circuit by connecting a second constant current circuit to a second diode group including another plurality of series-connected diodes and connecting the second diode group to a second resistor; connecting the second constant current circuit to the input terminal; inputting a first forward output voltage of the first diode group into the first input terminal of the differential amplifier circuit; inputting a second forward output voltage of the second diode group into the second input terminal of the differential amplifier circuit; causing the temperature monitoring circuit to monitor a temperature of the semiconductor integrated circuit apparatus; and causing the cut-off circuit to stop an operation of circuits included in the semiconductor integrated circuit apparatus according to an output signal output from the temperature monitoring circuit.

The overheat protection method may further include providing the temperature monitoring circuit with a thermal hysteresis.

In the overheat protection method, the first and second resistors may be replaced by a constant voltage circuit which outputs two different voltages.

The overheat protection method may further include: connecting the first input terminal of the differential amplifier circuit to a connection point between two diodes included in the first diode group; and connecting the second input terminal of the differential amplifier circuit to a connection point between two diodes included in the second diode group.

The overheat protection method may further include including a complementary metal oxide semiconductor circuit in the temperature monitoring circuit.

### BRIEF DESCRIPTION OF THE DRAWINGS

A more complete appreciation of the disclosure and many of the advantages thereof are readily obtained as the same becomes better understood by reference to the following detailed description when considered in connection with the accompanying drawings, wherein:

FIG. 1 is a circuit diagram illustrating a configuration of a voltage regulator circuit including a background overheat protection circuit;

FIG. 2 is a graph illustrating temperature characteristics of the background overheat protection circuit shown in FIG. 1;

FIG. 3 is a circuit diagram illustrating a schematic view of an overheat protection circuit according to an embodiment.

FIG. 4 is a circuit diagram illustrating a configuration of an overheat protection circuit according to an embodiment;

FIG. 5 is a graph illustrating temperature characteristics of the overheat protection circuit shown in FIG. 4 and an overheat protection circuit shown in FIG. 6;

FIG. 6 is a circuit diagram illustrating a configuration of the overheat protection circuit according to another embodiment;

FIG. 7 is a circuit diagram illustrating a configuration of an overheat protection circuit according to still another embodiment;

FIG. 8 is a graph illustrating temperature characteristics of the overheat protection circuit shown in FIG. 7 and an overheat protection circuit shown in FIG. 9; and

FIG. 9 is a circuit diagram illustrating a configuration of the overheat protection circuit according to still yet another embodiment.

### DETAILED DESCRIPTION OF PREFERRED EMBODIMENTS

In describing preferred embodiments illustrated in the drawings, specific terminology is employed for the purpose of clarity. However, the disclosure of this patent specification is not intended to be limited to the specific terminology so used and it is to be understood that substitutions for each specific element can include any technical equivalents that operate in a similar manner.

Referring now to the drawings, wherein like reference numerals designate identical or corresponding parts throughout the several views, more particularly to FIG. 3, a circuit diagram illustrating a schematic view of an overheat protection circuit 100 according to an embodiment is described.

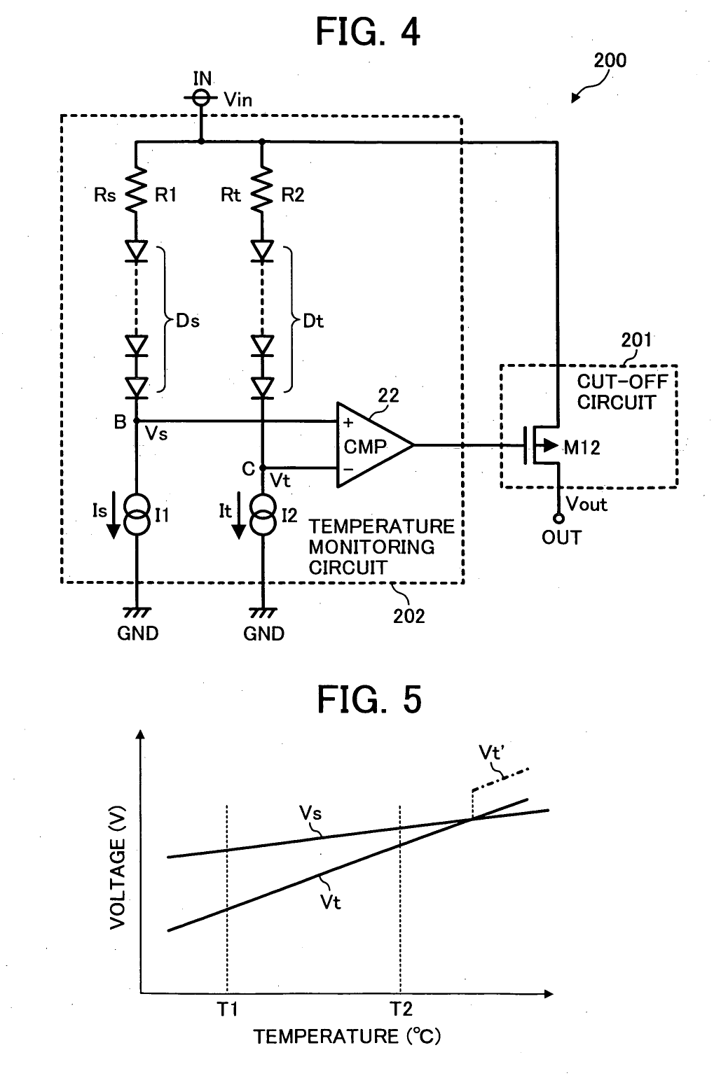

The overheat protection circuit 100 includes a temperature monitoring circuit 102 and a cut-off circuit 101. The temperature monitoring circuit 102 is connected to the cut-off circuit 101, and an output voltage Vout is output from an output terminal OUT. In the temperature monitoring circuit 102, two circuits which generate two voltages input in a comparator circuit (shown in FIG. 4) are formed by elements of approximately similar characteristics. Accordingly, a relationship between the two voltages input in the comparator circuit is kept constant even when the input voltage Vin changes, so that the operational error does not occur. Further, a resistance value of the temperature monitoring circuit 102 is changed so that the detection temperature can be set at a desired value. Upon a change in the relationship between the two voltages input in the comparator circuit, the level of the output voltage output from the comparator circuit shifts, and the cut-off circuit 101 is turned on.

FIG. 4 illustrates a configuration of an overheat protection circuit 200 according to an embodiment. The overheat protection circuit 200 includes a cut-off circuit 201 and a temperature monitoring circuit 202. The temperature monitoring circuit 202 receives an input voltage Vin input in an input terminal IN and outputs the output voltage Vout from the output terminal OUT.

The cut-off circuit 201 includes the p-channel transistor M12. The temperature monitoring circuit 202 includes a comparator circuit (CMP) 22, constant current circuits 11 and 12, resistors R1 and R2, and a diode group Ds including “s” number of diodes (s is an integer number larger than 1) and a diode group Dt including “t” number of diodes (t is an integer number larger than 1 and other than s). The resistor R1, the diode group Ds, and the constant current circuit I1 form a series circuit connected to a non-inverting input terminal of the comparator circuit 22. Meanwhile, the resistor R2, the diode group Dt, and the constant current circuit I2 form another series circuit connected to an inverting input terminal of the comparator circuit 22. A connection point B between the diode group Ds and the constant current circuit I1 is connected to the non-inverting input terminal of the comparator circuit 22, while a connection point C between the diode group Dt and the constant current circuit I2 is connected to the inverting input terminal of the comparator circuit 22. Accordingly, a voltage Vs at the connection point B is input in the non-inverting input terminal of the comparator circuit 22, and a voltage Vt at the connection point C is input in the inverting input terminal of the comparator circuit 22.

In the temperature monitoring circuit 202, Rs indicates a resistance value of the resistor R1, and Rt indicates a resistance value of the resistor R2. Further, Is indicates a value of current flowing through the series circuit including the resistor R1, the diode group Ds, and the constant current circuit I1, while It indicates a value of current flowing through the series circuit including the resistor R2, the diode group Dt, and the constant current circuit I2.

FIG. 5 is a graph illustrating voltage and temperature characteristics of the temperature monitoring circuit 202. An operation of the temperature monitoring circuit 202 shown in FIG. 4 is described with reference to the graph of FIG. 5. In FIG. 5, the horizontal axis represents temperature (degrees Celsius) of a surface of the semiconductor integrated circuit apparatus including the overheat protection circuit 200, and the vertical axis represents voltage (volts). A line Vs indicates a relationship between the voltage Vs and a temperature of a semiconductor integrated circuit apparatus including the overheat protection circuit 200, and a line Vt indicates a relationship between the voltage Vt and the temperature. Gradients of the lines Vs and Vt are determined by the number of diodes provided. The line Vt is steeper than the line Vs, since t is larger than s in the present embodiment.

When the temperature is T1, the voltage Vs input in the non-inverting input terminal of the comparator circuit 22 and the voltage Vt input in the inverting input terminal of the comparator circuit 22 are expressed as Vs=Vin−(Is*Rs+Vs1) and Vt=Vin−(It*Rt+Vt1), respectively, wherein Vs1 is a forward output voltage of the diode group Ds as measured when the constant current Is is flowed through the diode group Ds at the temperature T1, and Vt1 is a forward output voltage of the diode group Dt as measured when the constant current It is flowed through the diode group Dt at the temperature T1. In this state, an output voltage output from the comparator circuit 22 is at the HIGH level, and the p-channel transistor M12 is turned off.

Meanwhile, when the temperature is T2, the voltages Vs and Vt are expressed as Vs=Vin−(Is*Rs+Vs1−2*s*(T2−T1)) and Vt=Vin−(It*Rt+Vt1−2*t*(T2−T1)), respectively. That is, the Vs value measured at the temperature T2 is equal to the Vs value measured at the temperature T1 added with a change in the forward output voltage of the diode group Ds, and the Vt value measured at the temperature T2 is equal to the Vt value measured at the temperature T1 added with a change in the forward output voltage of the diode group Dt. Since a forward voltage of each diode decreases at a rate of two millivolts per degree Celsius, the Vs value measured at the temperature T2 is obtained by subtracting, from the Vs value measured at the temperature T1, a voltage value obtained by multiplying a difference between the temperatures T1 and T2 by the number of the diodes provided (i.e., s). Similarly, the Vt value measured at the temperature T2 is obtained by subtracting, from the Vt value measured at the temperature T1, a voltage value obtained by multiplying the difference between the temperatures T1 and T2 by the number of the diodes provided (i.e., t). Depending on values of s, t, Rs, and Rt, relationship between the voltages Vs and Vt measured at the temperature T2 can be expressed as one of Vs>Vt, Vs=Vt, and Vs<Vt.

If Vs is smaller than Vt (i.e., Vs<Vt) at the temperature T2, the output voltage output from the comparator circuit 22 (i.e., an output voltage output from the temperature monitoring circuit 202) changes from the HIGH level to the LOW level. Therefore, the p-channel transistor M12 of the cut-off circuit 201 is turned on, and an output driver of a circuit such as a regulator connected to the p-channel transistor M12 is turned off. Accordingly, the semiconductor integrated circuit apparatus including the overheat protection circuit 200 can be protected from overheat. The detection temperature of the overheat protection circuit 200 is a temperature at which the voltages Vs and Vt become equal.

The overheat protection circuit 200 according to the present embodiment has a relatively simply configuration, in which the circuits generating the two voltages Vs and Vt input in the comparator circuit 22 are formed by resistors and diodes. Therefore, the voltages Vs and Vt similarly change in response to a change in the input voltage Vin. Accordingly, the relationship between the voltages Vs and Vt is kept constant while the input voltage Vin changes.

In a region of the graph in FIG. 5 in which the lines of Vs and Vt cross and the voltage Vt exceeds the voltage Vs, the output voltage output from the comparator 22 is in an unstable state to cause heat oscillation. Therefore, it is preferable to provide a thermal hysteresis circuit in the temperature monitoring circuit 202 to prevent oscillation of the output voltage. The thermal hysteresis circuit can prevent the heat oscillation by increasing the voltage Vt to a higher voltage Vt′ at a moment when the voltage Vt reaches the voltage Vs (i.e., at a point where the Vt line crosses the Vs line). Instead of increasing the voltage Vt, the voltage Vs may be decreased. A circuit in which the voltage input in the non-inverting input terminal of the comparator is decreased is described later.

It is also preferable to make the resistance values Rs and Rt of the resistors R1 and R2 changeable by performing laser trimming. Accordingly, the detection temperature detected by the overheat protection circuit 200 can be set at an arbitrary value.

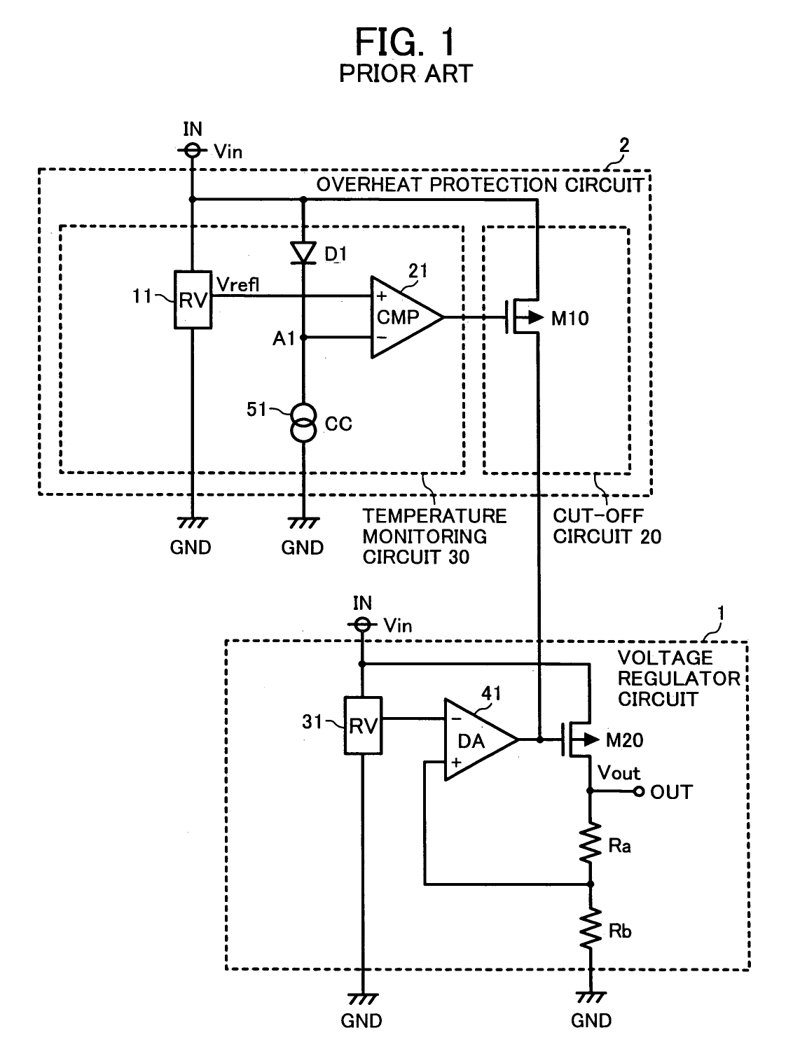

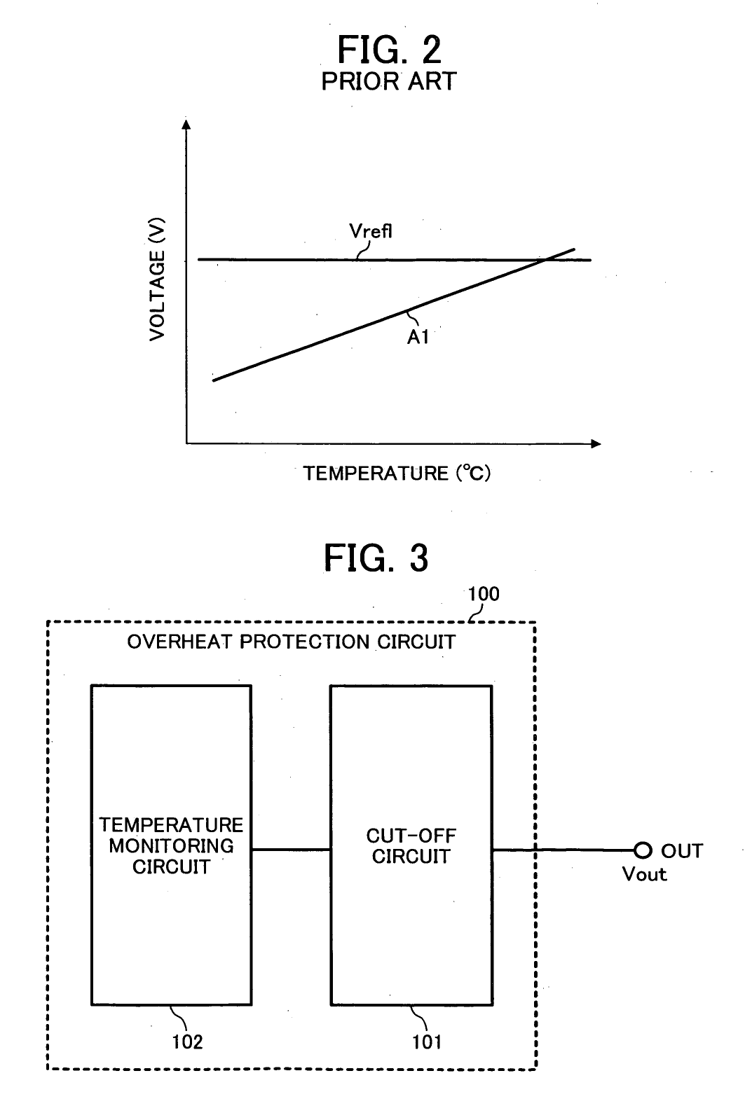

The resistors R1 and R2 may be replaced by a constant voltage circuit that receives the input voltage Vin and keeps output voltages constant. The voltage regulator circuit 1 shown in FIG. 1, for example, may be used as the constant voltage circuit.

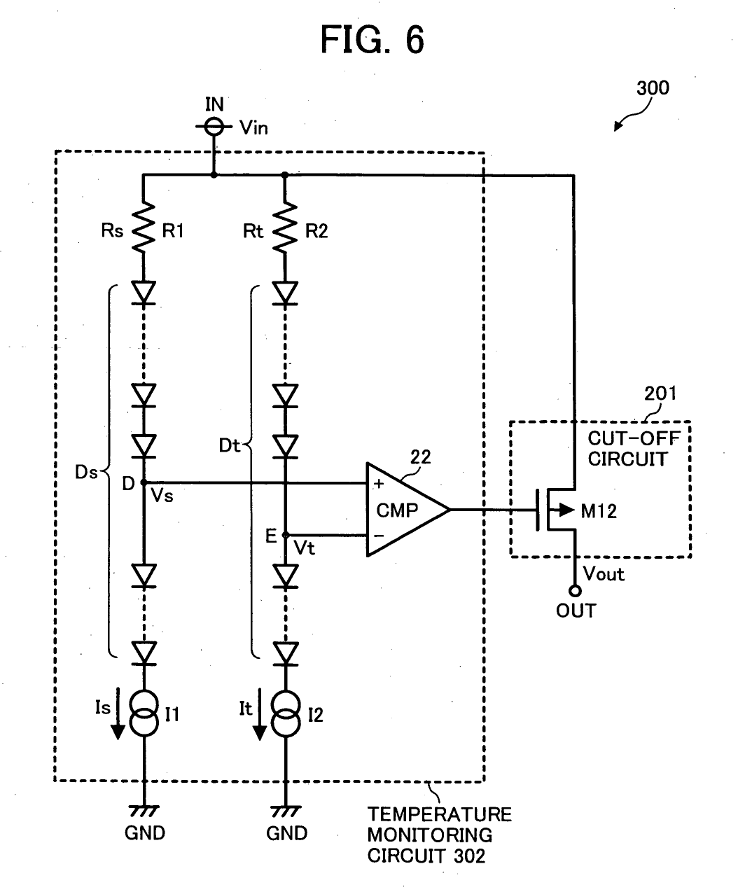

FIG. 6 illustrates an overheat protection circuit 300 according to another embodiment. Description is omitted for components shown in FIG. 6 which are also components shown in FIG. 4, and differences between the circuit configuration of FIG. 4 and the circuit configuration of FIG. 6 are described. The overheat protection circuit 300 includes a temperature monitoring circuit 302 and the cut-off circuit 201. The overheat protection circuit 300 is different from the overheat protection circuit 200 in that, in the temperature monitoring circuit 302, the non-inverting input terminal of the comparator circuit 22 is connected to a connection point D, which is a node between two diodes included in the diode group Ds, and the inverting input terminal of the comparator circuit 22 is connected to a connection point E, which is a node between two diodes included in the diode group Dt.

In the present embodiment, the resistor R1, the diode group Ds, and the constant current circuit I1 are connected in series, and the connection point D between a (s−q)-th diode and a (q+1)-th diode is connected to the non-inverting input terminal of the comparator circuit 22 (q is a positive integer number smaller than s). Meanwhile, the resistor R2, the diode group Dt, and the constant current circuit I2 are connected in series, and the connection point E between a (t−r)-th diode and a (r+1)-th diode is connected to the inverting input terminal of the comparator circuit 22 (r is a positive integer number smaller than t, and q and r may be or may not be the same number). In FIG. 6, at least one diode is placed between the connection point D and the constant current circuit I1 and between the connection point E and the constant current circuit I2. Voltage and temperature characteristics of the temperature monitoring circuit 302 are illustrated in the graph of FIG. 5.

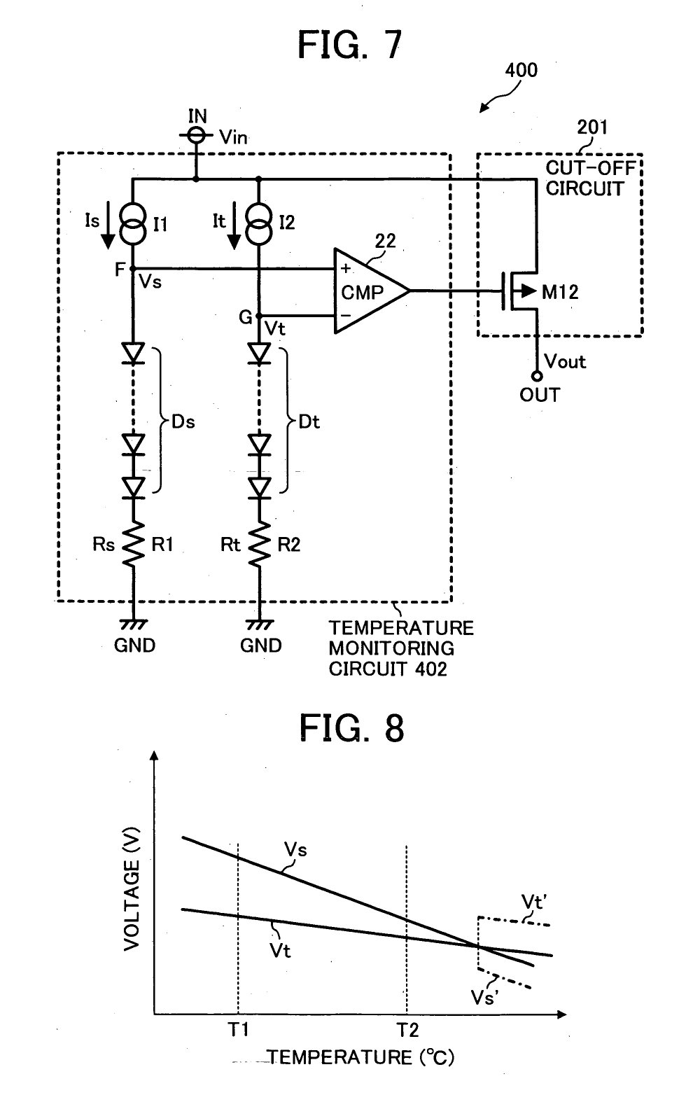

FIG. 7 illustrates a configuration of an overheat protection circuit 400 according to still another embodiment. Description is omitted for components shown in FIG. 7 which are also components shown in FIG. 4, and differences between the circuit configuration of FIG. 4 and the circuit configuration of FIG. 7 are described. The overheat protection circuit 400 includes the cut-off circuit 201 and a temperature monitoring circuit 402. The constant current circuit I1, the diode group Ds, and the resistor R1 form a series circuit connected to the non-inverting input terminal of the comparator circuit 22. Meanwhile, the constant current circuit I2, the diode group Dt, and the resistor R2 form another series circuit connected to the inverting input terminal of the comparator circuit 22. A connection point F between the constant current circuit I1 and the diode group Ds is connected to the non-inverting input terminal of the comparator circuit 22, while a connection point G between the constant current circuit I2 and the diode group Dt is connected to the inverting input terminal of the comparator circuit 22. The voltage Vs is input from the connection point F to the non-inverting input terminal of the comparator circuit 22, and the voltage Vt is input from the connection point G to the inverting input terminal of the comparator circuit 22. Rs indicates a resistance value of the resistor R1, and Rt indicates a resistance value of the resistor R2. Is indicates a value of current flowing through the series circuit including the constant current circuit I1, the diode group Ds, and the resistor R1, while It indicates a value of current flowing through the series circuit including the constant current circuit I2, the diode group Dt, and the resistor R2.

FIG. 8 is a graph illustrating voltage and temperature characteristics of the temperature monitoring circuit 400 shown in FIG. 7. An operation of the temperature monitoring circuit 402 is described with reference to the graph of FIG. 8. In FIG. 8, the horizontal axis represents temperature (degrees Celsius) of a surface of a semiconductor integrated circuit apparatus including the overheat protection circuit 400, and the vertical axis represents voltage (volts). A line Vs indicates a relationship between the voltage Vs and the temperature of the surface of the semiconductor integrated circuit apparatus including the overheat protection circuit 400, and a line Vt indicates a relationship between the voltage Vt and the temperature.

The voltage Vs input in the non-inverting input terminal of the comparator circuit 22 and the voltage Vt input in the inverting input terminal of the comparator circuit 22 are expressed as Vs=Is*Rs+Vs1 and Vt=It*Rt+Vt1, respectively, wherein Vs is larger than Vt (i.e., Vs>Vt). Vs1 is a forward output voltage of the diode group Ds as measured when the constant current Is is flowed through the diodes Ds at the temperature T1, and Vt1 is a forward output voltage of the diode group Dt as measured when the constant current It is flowed through the diode group Dt at the temperature T1. In this state, the output voltage output from the comparator circuit 22 is at the HIGH level, and the p-channel transistor M12 is turned off.

Meanwhile, when the temperature is T2, the voltages Vs and Vt are expressed as Vs=Is*Rs+Vs1−2*s*(T2−T1) and Vt=It*Rt+Vt1−2*t*(T2−T1), respectively. That is, the Vs value measured at the temperature T2 is equal to the Vs value measured at the temperature T1 added with a change in the forward output voltage of the diode group Ds, and the Vt value measured at the temperature T2 is equal to the Vt value measured at the temperature T1 added with a change in the forward output voltage of the diode group Dt. Since the forward voltage of each diode decreases at the rate of two millivolts per degree Celsius, the Vs value measured at the temperature T2 is obtained by subtracting, from the Vs value measured at the temperature T1, a voltage value obtained by multiplying a difference between the temperatures T1 and T2 by the number of the diodes provided (i.e., s). Similarly, the Vt value measured at the temperature T2 is obtained by subtracting, from the Vt value measured at the temperature T1, a voltage value obtained by multiplying the difference between the temperatures T1 and T2 by the number of the diodes provided (i.e., t). Depending on values of s, t, Rs, and Rt, relationship between the voltages Vs and Vt measured at the temperature T2 can be expressed as one of Vs>Vt, Vs=Vt, and Vs<Vt.

If Vs is smaller than Vt (i.e., Vs<Vt) at the temperature T2, the output voltage output from the comparator circuit 22 (i.e., an output voltage output from the temperature monitoring circuit 402) shifts from the HIGH level to the LOW level. Therefore, the p-channel transistor M12 of the cut-off circuit 201 is turned on, and an output driver of a circuit such as a regulator connected to the p-channel transistor M12 is turned off. Accordingly, the semiconductor integrated circuit apparatus including the overheat protection circuit 400 can be protected from overheat. The detection temperature of the overheat protection circuit 400 is a temperature at which the voltages Vs and Vt become equal. Vs' is a value decreased from Vs due to a thermal hysteresis, and Vt′ is a value increased from Vt due to the thermal hysteresis. A hysteresis circuit is provided in the temperature monitoring circuit 402, and when the output voltage output from the comparator circuit 22 is shifted in level, the voltage Vt is increased to the voltage Vt′ or the voltage Vs is decreased to the voltage Vs′. Accordingly, the unstable state of the output voltage output from the comparator circuit 22 due to the heat oscillation can be prevented.

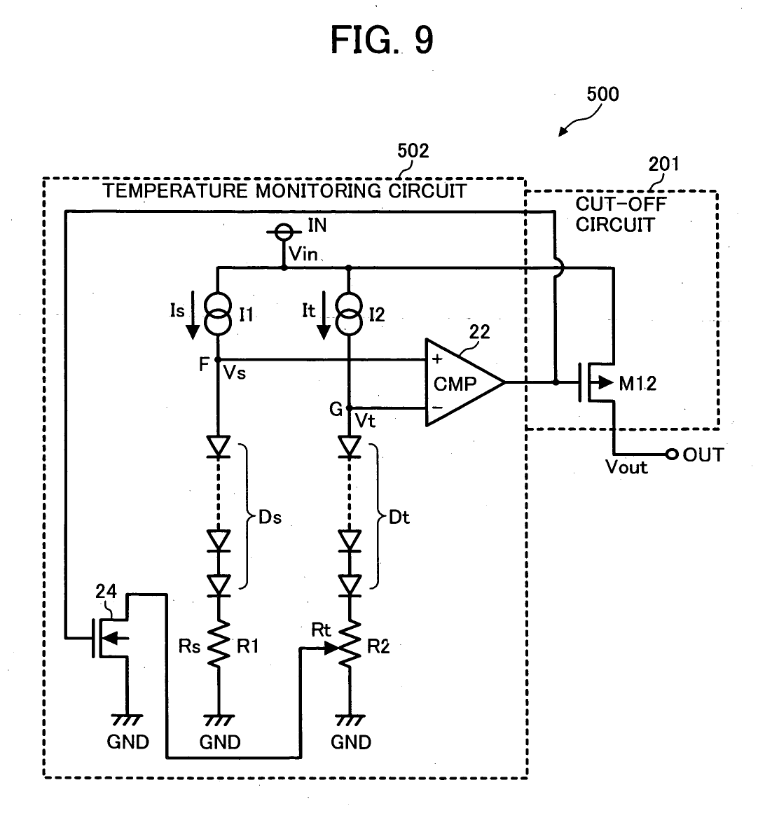

FIG. 9 illustrates a configuration of an overheat protection circuit 500 according to still yet another embodiment. Description is omitted for components shown in FIG. 9 which are also components shown in FIG. 7, and differences between the circuit configuration of FIG. 7 and the circuit configuration of FIG. 9 are described. The overheat protection circuit 500 includes a temperature monitoring circuit 502 and the cut-off circuit 201. The overheat protection circuit 500 is different from the overheat protection circuit 400 in that the overheat protection circuit 500 includes an n-channel transistor 24 to form a hysteresis circuit in the temperature monitoring circuit 502.

In the overheat protection circuit 500, the hysteresis circuit is formed by connecting a drain of the n-channel transistor 24 to an arbitrary point in the resistor R2. Further, a source of the n-channel transistor 24 is connected to the ground (GND), and a gate of the n-channel transistor 24 is connected to a gate of the p-channel transistor M12 of the cut-off circuit 201.

When it is assumed that R1 is a resistance value of a portion of the resistor RN on a ground side from the arbitrary point and R2 is a resistance value of a portion of the resistor RN on a power-source side from the arbitrary point, Rt is expressed as Rt=R1+R2. Since the output voltage output from the comparator circuit 22 is at the HIGH level in a state in which the voltages Vs and Vt input in the comparator circuit 22 are not yet shifted, the n-channel transistor 24 is turned on. In this state, a resistance value of a portion of the resistor R2 on the side of the inverting input terminal of the comparator circuit 22 is R2. Therefore, a voltage of the resistor R2 is expressed as R2*It. When the voltages Vs and Vt input in the comparator circuit 22 shift, however, the output voltage output from the comparator circuit 22 shifts from the HIGH level to the LOW level. As a result, the n-channel transistor 24 is turned off, and the voltage of the resistor R2 is expressed as (R1+R2)*It which is higher, by a value R1*It, than the voltage of the resistor R2 measured before the shift of the voltages Vs and Vt. The value R1*It is equal to Vt′−Vt.

Voltage and temperature characteristics of the temperature monitoring circuit 502 are illustrated in the graph of FIG. 8. In the present embodiment shown in FIG. 9, Vt is increased to Vt′ due to the hysteresis. Alternatively, the voltage Vs may be decreased to Vs' due to the hysteresis when the levels of the voltages Vs and Vt are shifted.

As described above, in the temperature monitoring circuits according to the above embodiments, the circuits which generate the two voltages input in the comparator circuit are formed by the constant current circuits, the resistors, and the diodes. Further, the resistors and the diodes are connected to the two input terminals of the comparator circuit. Therefore, the two voltages input in the comparator circuit similarly change to the change in the input voltage Vin. As a result, the relationship between the two voltages are kept constant while the input voltage Vin changes. Preferably, the comparator circuit may have a thermal hysteresis effect or the laser trimming may be performed to obtain the desired detection temperature.

In the above embodiments, the circuits which generate the two voltages input in the comparator circuit of the temperature monitoring circuit are approximately similar in characteristics, and the elements connected to the two input terminals of the comparator circuit are similar in characteristics. Accordingly, even when the input voltage Vin changes, the relationship between the two voltages input in the comparator circuit is kept constant, and the operational errors can be prevented.

Further, the resistance values of the temperature monitoring circuits according to the above embodiments can be changed by performing the laser trimming. Accordingly, the detection temperature can be set at the desired value.

In the above embodiments, the constant currents are flowed through the resistors to generate voltages. If the resistance values and the constant current values are affected by manufacturing variation and temperature dependence of the resistors and the constant current circuits, the voltages generated by the resistors are varied. In order to reduce this variation, there is a method of adjusting the resistance values and the constant current values by performing the laser trimming in post-processes. Alternatively, the constant voltage circuit may be used. For example, if a voltage regulator is used, a relatively accurate output voltage can be obtained, and thus the adjustment by the laser trimming performed in the post-processes is not necessary. Accordingly, manufacturing costs can be reduced.

The above-described embodiments are illustrative, and numerous additional modifications and variations are possible in light of the above teachings. For example, elements and/or features of different illustrative and exemplary embodiments herein may be combined with each other and/or substituted for each other within the scope of this disclosure and appended claims. It is therefore to be understood that within the scope of the appended claims, the disclosure of this patent specification may be practiced otherwise than as specifically described herein.

This patent specification is based on Japanese patent application No. 2004-162941 filed on Jun. 1, 2004 in the Japan Patent Office, the entire contents of which are incorporated by reference herein.

1. A semiconductor integrated circuit apparatus having an overheat protection circuit, comprising:
a voltage generating circuit configured to generate two reference voltages having substantially equivalent responsiveness to an input voltage and different variation gradients with respect to a temperature change such that the different variation gradients intersect with each other at a predetermined temperature;
a voltage comparing circuit configured to compare the two reference voltages generated by the voltage generating circuit; and
a voltage outputting circuit configured to output an output voltage when the different variation gradients do not intersect and to change the output voltage to an inverse output voltage upon intersection of the different variation gradients to stop an operation of circuits included in the semiconductor integrated circuit apparatus.

2. A semiconductor integrated circuit apparatus comprising:
an input terminal; and
an overheat protection circuit comprising:
a temperature monitoring circuit configured to monitor a temperature of the semiconductor integrated circuit apparatus; and
a cut-off circuit configured to stop an operation of circuits included in the semiconductor integrated circuit apparatus according to an output signal output from the temperature monitoring circuit; the temperature monitoring circuit comprising:
a first series circuit configured to connect a first resistor to a first diode group including a plurality of series-connected diodes and to connect the first diode group to a first constant current circuit, the first resistor being connected to the input terminal;
a second series circuit configured to connect a second resistor to a second diode group including another plurality of series-connected diodes and to connect the second diode group to a second constant current circuit, the second resistor being connected to the input terminal; and
a differential amplifier circuit having a first input terminal to receive a first forward output voltage of the first diode group and a second input terminal to receive a second forward output voltage of the second diode group.

3. The semiconductor integrated circuit apparatus as described in claim 2, wherein the temperature monitoring circuit has a thermal hysteresis.

4. The semiconductor integrated circuit apparatus as described in claim 2, wherein laser trimming is performed in a post-process to adjust a resistance value of one of the first and second resistors or a constant current value of one of the first and second constant current circuits.

5. The semiconductor integrated circuit apparatus as described in claim 2, wherein the first and second resistors are replaced by a constant voltage circuit which outputs two different voltages.

6. The semiconductor integrated circuit apparatus as described in claim 2, wherein the first input terminal of the differential amplifier circuit is connected to a connection point between two diodes included in the first diode group, and the second input terminal of the differential amplifier circuit is connected to a connection point between two diodes included in the second diode group.

7. The semiconductor integrated circuit apparatus as described in claim 2, wherein the temperature monitoring circuit includes a complementary metal oxide semiconductor circuit.

8. A semiconductor integrated circuit apparatus comprising:
an input terminal; and
an overheat protection circuit comprising:
a temperature monitoring circuit configured to monitor a temperature of the semiconductor integrated circuit apparatus; and
a cut-off circuit configured to stop an operation of circuits included in the semiconductor integrated circuit apparatus according to an output signal output from the temperature monitoring circuit; the temperature monitoring circuit comprising:
a first series circuit configured to connect a first constant current circuit to a first diode group including a plurality of series-connected diodes and to connect the first diode group to a first resistor, the first constant current circuit being connected to the input terminal;
a second series circuit configured to connect a second constant current circuit to a second diode group including another plurality number of series-connected diodes and to connect the second diode group to a second resistor, the second constant current circuit being connected to the input terminal; and
a differential amplifier circuit having a first input terminal to receive a first forward output voltage of the first diode group and a second input terminal to receive a second forward output voltage of the second diode group.

9. The semiconductor integrated circuit apparatus as described in claim 8, wherein the temperature monitoring circuit has a thermal hysteresis.

10. The semiconductor integrated circuit apparatus as described in claim 8, wherein the first and second resistors are replaced by a constant voltage circuit which outputs two different voltages.

11. The semiconductor integrated circuit apparatus as described in claim 8, wherein the first input terminal of the differential amplifier circuit is connected to a connection point between two diodes included in the first diode group, and the second input terminal of the differential amplifier circuit is connected to a connection point between two diodes included in the second diode group.

12. The semiconductor integrated circuit apparatus as described in claim 8, wherein the temperature monitoring circuit includes a complementary metal oxide semiconductor circuit.

13. A semiconductor integrated circuit apparatus having an overheat protection circuit, comprising:
voltage generating means for generating two reference voltages having substantially equivalent responsiveness to an input voltage and different variation gradients with respect to a temperature change such that the different variation gradients intersect with each other at a predetermined temperature;
voltage comparing means for comparing the two reference voltages generated by the voltage generating means; and
voltage outputting means for outputting an output voltage when the different variation gradients do not intersect and to change the output voltage to an inverse output voltage upon intersection of the different variation gradients to stop an operation of circuits included in the semiconductor integrated circuit apparatus.

14. A semiconductor integrated circuit apparatus comprising:
an input terminal; and
overheat protection means comprising:
temperature monitoring means for monitoring a temperature of the semiconductor integrated circuit apparatus; and
cut-off means for stopping an operation of circuits included in the semiconductor integrated circuit apparatus according to an output signal output from the temperature monitoring means; the temperature monitoring means comprising:
first series circuit means for connecting first resistor means to first diode means including a plurality of series-connected diodes and for connecting the first diode means to first constant current generating means, the first resistor means being connected to the input terminal;
second series circuit means for connecting second resistor means to second diode means including another plurality number of series-connected diodes and for connecting the second diode means to second constant current generating means, the second resistor means being connected to the input terminal; and
differential amplifier means having a first input terminal to receive a first forward output voltage of the first diode means and a second input terminal to receive a second forward output voltage of the second diode means.

15. The semiconductor integrated circuit apparatus as described in claim 14, wherein the temperature monitoring means has a thermal hysteresis.

16. The semiconductor integrated circuit apparatus as described in claim 14, wherein laser trimming is performed in a post-process to adjust a resistance value of one of the first and second resistor means or a constant current value of one of the first and second constant current generating means.

17. The semiconductor integrated circuit apparatus as described in claim 14, wherein the first and second resistor means are replaced by constant voltage generating means for outputting two different voltages.

18. The semiconductor integrated circuit apparatus as described in claim 14, wherein the first input terminal of the differential amplifier means is connected to a connection point between two diodes included in the first diode means, and the second input terminal of the differential amplifier means is connected to a connection point between two diodes included in the second diode means.

19. The semiconductor integrated circuit apparatus as described in claim 14, wherein the temperature monitoring means includes a complementary metal oxide semiconductor circuit.

20. A semiconductor integrated circuit apparatus comprising:
an input terminal; and
overheat protection means comprising:
temperature monitoring means for monitoring a temperature of the semiconductor integrated circuit apparatus; and
cut-off means for stopping an operation of circuits included in the semiconductor integrated circuit apparatus according to an output signal output from the temperature monitoring means; the temperature monitoring means comprising:
first series circuit means for connecting first constant current generating means to first diode means including a plurality of series-connected diodes and for connecting the first diode means to first resistor means, the first constant current generating means being connected to the input terminal;
second series circuit means for connecting second constant current generating means to second diode means including another plurality of series-connected diodes and for connecting the second diode means to second resistor means, the second constant current generating means being connected to the input terminal; and
differential amplifier means having a first input terminal to receive a first forward output voltage of the first diode means and a second input terminal to receive a second forward output voltage of the second diode means.

21. The semiconductor integrated circuit apparatus as described in claim 20, wherein the temperature monitoring means has a thermal hysteresis.

22. The semiconductor integrated circuit apparatus as described in claim 20, wherein the first and second resistor means are replaced by constant voltage generating means for outputting two different voltages.

23. The semiconductor integrated circuit apparatus as described in claim 20, wherein the first input terminal of the differential amplifier means is connected to a connection point between two diodes included in the first diode means, and the second input terminal of the differential amplifier means is connected to a connection point between two diodes included in the second diode means.

24. The semiconductor integrated circuit apparatus as described in claim 20, wherein the temperature monitoring means includes a complementary metal oxide semiconductor circuit.

25. An overheat protection method for protecting a semiconductor integrated circuit apparatus from overheat, the overheat protection method comprising:
generating two reference voltages having substantially equivalent responsiveness to an input voltage and different variation gradients with respect to a temperature change such that the different variation gradients intersect with each other at a predetermined temperature;
comparing the two reference voltages generated by the generating step;
outputting an output voltage when the different variation gradients do not intersect; and
changing the output voltage to an inverse output voltage upon intersection of the different variation gradients to stop an operation of circuits included in the semiconductor integrated circuit apparatus.

26. An overheat protection method for protecting a semiconductor integrated circuit apparatus from overheat, the overheat protection method comprising:
providing an input terminal and an overheat protection circuit configured to include a temperature monitoring circuit and a cut-off circuit;
providing the temperature monitoring circuit with first and second series circuits and a differential amplifier circuit including first and second input terminals;
forming the first series circuit by connecting a first resistor to a first diode group including a plurality of series-connected diodes and connecting the first diode group to a first constant current circuit;
forming the second series circuit by connecting a second resistor to a second diode group including another plurality number of series-connected diodes and connecting the second diode group to a second constant current circuit;
connecting the first and second resistors to the input terminal;
inputting a first forward output voltage of the first diode group into the first input terminal of the differential amplifier circuit;
inputting a second forward output voltage of the second diode group into the second input terminal of the differential amplifier circuit;
causing the differential amplifier circuit to compare the first and second forward output voltages and output an output voltage; and
causing the cut-off circuit to stop an operation of circuits included in the semiconductor integrated circuit apparatus according to the output signal output from the differential amplifier circuit.

27. The overheat protection method as described in claim 26, further comprising:
providing the temperature monitoring circuit with a thermal hysteresis.

28. The overheat protection method as described in claim 26, further comprising:
performing laser trimming in a post-process to adjust a resistance value of one of the first and second resistors or a constant current value of one of the first and second constant current circuits.

29. The overheat protection method as described in claim 26, wherein the first and second resistors are replaced by a constant voltage circuit which outputs two different voltages.

30. The overheat protection method as described in claim 26, further comprising:
connecting the first input terminal of the differential amplifier circuit to a connection point between two diodes included in the first diode group; and
connecting the second input terminal of the differential amplifier circuit to a connection point between two diodes included in the second diode group.

31. The overheat protection method as described in claim 26, further comprising:
including a complementary metal oxide semiconductor circuit in the temperature monitoring circuit.

32. An overheat protection method for protecting a semiconductor integrated circuit apparatus from overheat, the overheat protection method comprising:
providing an input terminal and an overheat protection circuit configured to include a temperature monitoring circuit and a cut-off circuit;
providing the temperature monitoring circuit with first and second series circuits and a differential amplifier circuit configured to have first and second input terminals;
forming the first series circuit by connecting a first constant current circuit to a first diode group including a plurality of series-connected diodes and connecting the first diode group to a first resistor;
forming the second series circuit by connecting a second constant current circuit to a second diode group including another plurality of series-connected diodes and connecting the second diode group to a second resistor;
connecting the first and second constant current circuits to the input terminal;
inputting a first forward output voltage of the first diode group into the first input terminal of the differential amplifier circuit;
inputting a second forward output voltage of the second diode group into the second input terminal of the differential amplifier circuit;
causing the differential amplifier circuit to compare the first and second forward output voltages and output an output voltage; and
causing the cut-off circuit to stop an operation of circuits included in the semiconductor integrated circuit apparatus according to the output signal output from the differential amplifier circuit.

33. The overheat protection method as described in claim 32, further comprising:
providing the temperature monitoring circuit with a thermal hysteresis.

34. The overheat protection method as described in claim 32, wherein the first and second resistors are replaced by a constant voltage circuit which outputs two different voltages.

35. The overheat protection method as described in claim 32, further comprising:
connecting the first input terminal of the differential amplifier circuit to a connection point between two diodes included in the first diode group; and
connecting the second input terminal of the differential amplifier circuit to a connection point between two diodes included in the second diode group.

36. The overheat protection method as described in claim 32, further comprising including a complementary metal oxide semiconductor circuit in the temperature monitoring circuit.
